(19) United States
(12) Patent Application Publication
(10) Pub. No.: US 2021/0054241 A1
(43) Pub. Date: Feb. 25, 2021

(54) ADHESIVE ELEMENT, OPENING CLOSED OFF WITH THE ADHESIVE ELEMENT, SUCH AS A CONSTRUCTION HOLE, A BODY HOLE, A PAINT DRAIN HOLE AND/OR A PAINT DRAIN OPENING, AND SYSTEM CONSISTING OF THE ADHESIVE ELEMENT AND A CARRIER ELEMENT

(71) Applicant: SIKA TECHNOLOGY AG, Baar (CH)

(72) Inventors: Zdislaw KORNACKI, Nidderau (DE); Christian HARDT, Kelsterbach (DE); Frederick SCHWAB, Frankfurt (DE); Wolf-Peter SANDER, Nidderau (DE); Sebastian BEUTEL, Günzburg (DE)

(73) Assignee: SIKA TECHNOLOGY AG, Baar (CH)

(21) Appl. No.: 16/766,592

(22) PCT Filed: Nov. 21, 2018
(86) PCT No.: PCT/EP2018/082129

§ 371 Date: May 22, 2020

(30) Foreign Application Priority Data
Nov. 22, 2017 (DE) 10 2017 127 618.1

(51) Int. Cl. C09J 7/35; C09J 121/00; C09J 11/08

(52) U.S. Cl. CPC C09J 7/35; C09J 121/00; C09J 2301/122; C09J 2400/16; C09J 11/08

(57) ABSTRACT

An adhesive element including a cover layer and a self-adhering sealant, wherein the self-adhering sealant is a thermoactive or thermoactivated rubber compound.

The present invention relates to an adhesive element, an opening such as a construction hole, a bodywork hole, a surface coating outflow hole and/or a surface coating outflow opening, and a system composed of adhesive element and support element.

Such adhesive elements are, for example, known from the document DE 10 2008 050 772 A1 and preferably serve for closing production-related openings, e.g. in a vehicle body. Main constituents of these adhesive elements are a covering layer and a self-adhesive sealing composition. Since the adhesive element is intended to close the openings, for example a construction hole, a bodywork hole, a surface coating outflow hole and/or a surface coating outflow opening, on a long-term basis, for example during further manufacturing steps and in particular in the finished state of the vehicle body, this type of adhesive element has to meet more demanding requirements. In particular, the adhesive element should be thermally stable and resistant to process media used in the manufacturing process and also to the temperatures and heating times prevailing in the manufacturing process for the vehicle body. In addition, the adhesive element should be able to adhere to bodywork surfaces, in particular to a bodywork surface coated with a cathodic dip coating (CDC) without suffering a significant long-term reduction in adhesive force. In addition, thixotropic properties, thermal reactivity, impermeability to liquid media, in particular to aqueous solutions, and a certain weathering resistance in the finished state of the vehicle body are desirable.

It is likewise of considerable practical importance that the adhesive element can withstand a very high penetration force when it closes a production-related opening.

It is therefore an object of the present invention to provide an adhesive element which satisfies the abovementioned requirements, in particular in respect of the resistance to media and penetration force.

This object is achieved by an adhesive element as claimed in claim 1 and a process as claimed in claim 10. Further advantages and features of the invention can be derived from the dependent claims and also the description and the accompanying figures.

The invention provides an adhesive element comprising
a covering layer and
a self-adhesive sealing composition,

Wherein the self-adhesive sealing composition is a thermoactive, i.e. thermally reactive, or thermoactivated, i.e. thermally crosslinked, rubber composition.

Compared to the prior art, it has surprisingly been found that the desired properties, in particular in respect of the impermeability of the adhesive bond, the resistance to media and penetration force, can be set or realized in a targeted manner by means of a thermoactive or thermoactivated rubber composition as sealing composition. Here, the thermoactivated and thus crosslinked rubber composition is rubber-like (comparable to a tire material). In particular, the rubber composition of the invention makes it possible to achieve a penetration force of more than 300 N, in particular more than 400 N and even more than 500 N, and a higher adhesion compared to the adhesive elements known from the prior art. Long-term sealing of an opening or a hole, in particular a construction hole, a bodywork hole, a surface coating outflow hole and/or a surface coating outflow opening, can be ensured here. In addition, the adhesive element can be provided with such a configuration that adhesion of the adhesive element is essentially independent of temperature and the adhesive element is insoluble in the presence of fuel media, mineral and synthetic oils and also brake fluids and other solvents. In addition, it has been found that a stone-impact-resistant and cold-resistant adhesive element can advantageously be realized by means of the thermoactive or thermoactivated rubber composition as sealing composition.

Fundamentally, a thermoactive or thermoactivated rubber composition is preferably a rubber composition which acquires the desired properties after introduction of thermal energy, for example by means of warming or heating. Here, “thermoactive” preferably refers to the state of the rubber composition before introduction of thermal energy and “thermoactivated” preferably refers to the state of the rubber composition after introduction of thermal energy. The adhesive element is preferably an element intended for closing production-related openings in a vehicle body. For example, the adhesive element is for this purpose pad-like or strip-like in shape and is arranged on a support element, known as a liner, before assembly. In particular, the thermoactive or thermoactivated rubber composition has a multi-component composition, i.e. it is composed of a plurality of constituents, in particular different types of rubber. Furthermore, a person skilled in the art will, in particular, equate the terms thermoactive and thermoactivated with thermally crosslinkable or thermally crosslinked. Here, a thermal treatment brings about an acceleration of the crosslinking process in which a self-adhesive viscous composition is converted into a thermoset or permanently elastic, mechanically strong, rubber-like composition, i.e. the thermoactive rubber composition is partially or fully cured.

Furthermore, it is conceivable for the adhesive element to be configured so that the adhesive element is thermoactivated during the process for manufacturing a vehicle body, i.e. the thermal energy is introduced during the manufacturing process. For example, the introduction of the thermal energy is effected together with the surface coating or drying of the body. In this way, the curing of the rubber composition can occur during the process for manufacturing the vehicle body, which advantageously enables time to be saved. The thermoactive rubber composition is preferably configured or composed, i.e. adapted, so that the thermoactive rubber composition can be thermoactivated, i.e. converted into a thermoactivated state, at temperatures which occur in a particular manufacturing step.

In a further embodiment of the present invention, the covering layer comprises a metal layer, in particular a corrosion-protected metal layer, a polymer layer and/or a nonwoven layer. The covering layer enables an advantageous dimensional stability of the adhesive element to be achieved and the sealing composition is protected by the covering layer in the assembled state. The metal layer preferably has a thickness viewed in the coating direction of from 0.1 to 1 mm, preferably a thickness of from 0.1 to 0.5 mm and particularly preferably a thickness of 0.2 mm. For example, the covering layer comprises an aluminum layer which is coated on both sides with a conversion coating of zirconium Zr and/or a surface coating composition, in particular a cured surface coating composition. Corrosion protection for the adhesive element can advantageously be achieved in this way.

In a further embodiment of the present invention, the rubber composition is configured so that it is converted, in particular completely, into a thermoactivated state by heating above a temperature threshold for a residence time. The temperature threshold is preferably above 135° C., preferably above 140° C. and particularly preferably above 160° C., and the residence time is essentially 30 minutes and/or more than 20 minutes.

The thermoactive rubber composition preferably comprises a first type of rubber, a second type of rubber, a hydrocarbon resin, an organic crosslinker, a catalyst, a dye, a thermal stabilizer and/or a moisture remover. This makes it possible to realize a thermoactive rubber composition having the desired properties in a targeted manner.

In a further embodiment of the present invention, the thermoactive rubber composition comprises a filler.

A ratio of a proportion of rubber to the proportion of fillers expediently assumes a value in the range from 0.3 to 0.8, preferably from 0.4 to 0.7 and particularly preferably from 0.45 to 0.6.

In particular,
a proportion of a first type of rubber assumes a value in the range from 5% to 25%, preferably from 6 to 15% and particularly preferably from 7% to 10%,
a proportion of a second type of rubber assumes a value in the range from 10% to 45%, preferably from 15 to 30% and particularly preferably from 18% to 23%, and/or
a proportion of the filler assumes a value in the range from 40% to 70%, preferably from 45% to 65% and particularly preferably from 48% to 59%.

The rubber composition particularly preferably comprises

| | |
|---|---|
| 7.0-10.0% | of a first type of rubber |
| 18.0-23.0% | of a second type of rubber |
| 8.0-10.0% | of hydrocarbon resin |
| 1.5-3.0% | of organic crosslinker |
| 0.5-2.0% | of catalyst |
| 0.2-0.6% | of dye |
| 2.5-4.0% | of thermal stabilizers and moisture removers and |
| 48.0-59.0% | of mineral fillers. |

The first type of rubber and the second type of rubber are preferably types of unsaturated rubber.

In a further embodiment of the present invention, the adhesive element will withstand a penetration force of from 300 to 900 N. This makes it advantageously possible to provide an adhesive element which advantageously withstands not only the mechanical compressive stresses acting on the adhesive element closing the opening in the assembled state which usually occur in the manufacturing process of a vehicle body but also those during use by the end customer. To determine the penetration force, preference is given to employing a Stöckel shoe test. To determine the impermeability of the adhesive bond, a 500 mm water column test is preferably employed.

In a further embodiment of the present invention, the rubber composition is sulfur-free. In this way, an essentially odorless adhesive element can advantageously be provided.

The present invention further provides a process for producing an adhesive element, in particular an adhesive element according to the invention, comprising the steps:
provision of an adhesive element comprising a covering layer and a self-adhesive sealing composition comprising a thermoactive or thermoactivated rubber composition and
introduction of thermal energy to convert the thermoactive rubber composition into a thermoactivated rubber composition.

All features described for the adhesive element of the invention and the advantages thereof apply analogously also to the process of the invention and vice versa.

In particular, the components forming the rubber composition, in particular in the above-described amounts, are combined or mixed in a mixing apparatus, preferably a kneading apparatus, in order to provide the sealing composition. Particular preference is here given to the first type of rubber, the second type of rubber, the resins, the mineral and organic fillers and/or minor components being kneaded to give a homogeneously and comparatively highly viscous composition. The components are heated before or during the mixing operation. After conclusion of a mixing time, in particular a predetermined mixing time, and cooling to a temperature in the range from 80° C. to 120° C., preferably to a temperature in the range from 90° C. to 120° C. and particularly preferably to a temperature in the range from 95° C. to 115° C., the mixed and/or kneaded components are mixed with reactive components and/or catalysts in an extruder, in particular an external extruder.

After mixing, the the thermoactive composition is discharged from the extruder, in particular onto a cooled liner. The composition extruded onto the liner is particularly preferably shaped by means of a doctor blade to give a film. The self-adhesive thermoactive composition which has been converted into film form is subsequently laminated with a covering layer, in particular a covering layer composed of surface-coated aluminum. The adhesive elements are stamped out from the composite comprising the covering layer of aluminum and the thermoactive film. The stamped-out adhesive elements can be reused as self-adhesive closures which can be applied automatically to close construction holes of the automobile body.

The present invention further provides an opening, in particular an opening in a bodywork part of a vehicle, for example a construction hole, a bodywork hole, a surface coating outflow hole and/or a surface coating outflow opening, which has been closed by means of an adhesive element according to the invention. All features described for the adhesive element of the invention and the advantages thereof apply analogously also to the opening of the invention and vice versa.

The present invention further provides a system composed of support element and adhesive element of the invention. All features described for the adhesive element of the invention and the advantages thereof apply analogously also to the system of the invention and vice versa.

Further advantages and features may be derived from the following description of preferred embodiments of the subject matter of the invention with reference to the accompanying figures. The figures show:

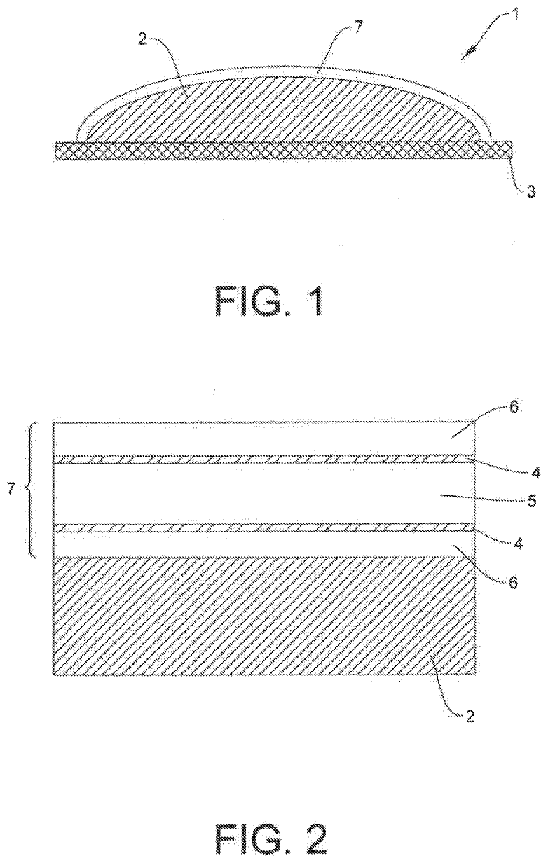

FIG. 1: an adhesive element as per a preferred embodiment of the present invention,

FIG. 2: a section of FIG. 1,

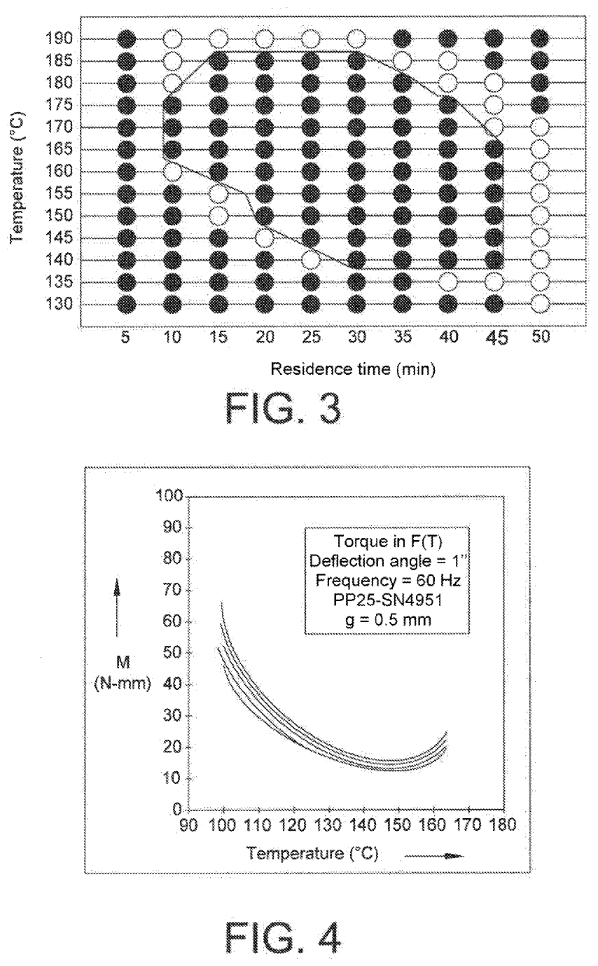

FIG. 3 a graph of a satisfactory or required degree of curing as a function of a residence time and a temperature,

FIG. 4 a graph of a torque as a function of a temperature,

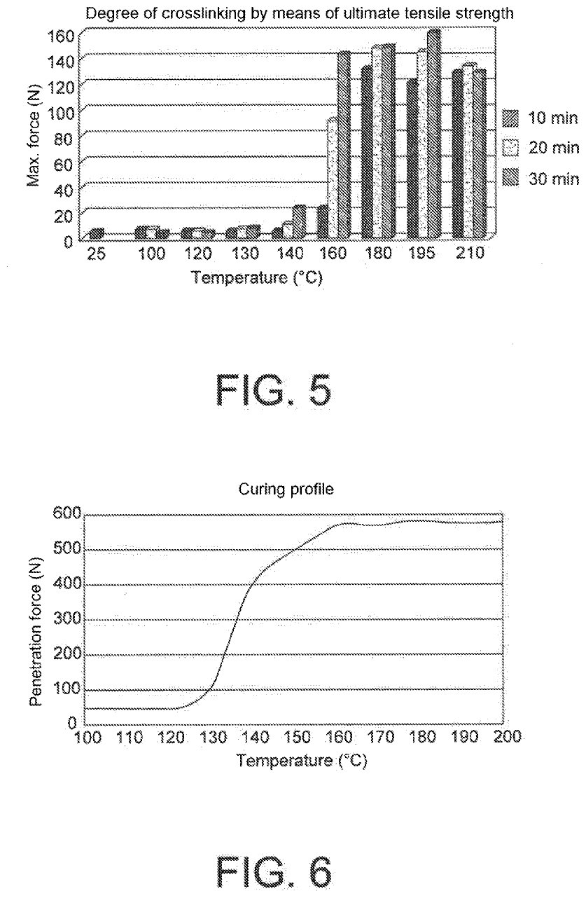

FIG. 5 a graph of a degree of crosslinking as a function of a temperature and

FIG. 6 a graph of a penetration force as a function of a temperature.

FIG. 1 depicts an adhesive element 1 as per an illustrative embodiment of the present invention. In particular, the adhesive element here is of the type of adhesive elements 1, for example in the form of adhesive strips or adhesive pads, which are intended for sealing or closing manufacturing-related openings of the vehicle component. Significant constituents are a covering layer and a self-adhesive sealing composition. In the present working example, the adhesive element 1 has a pad-like shape, i.e. the covering layer surrounds the sealing composition in a dome-like manner. The covering layer 7 is preferably a primary layer, for example a metal layer 5 such as an aluminum layer. The metal layer 5 preferably has a thickness viewed in the coating direction of from 0.1 to 1 mm, preferably a thickness of from 0.1 to 0.5 mm and particularly preferably a thickness of 0.2 mm. As is shown in the detail in FIG. 2, the covering layer 7 has a conversion layer 4, preferably a conversion layer 4 comprising zirconium (Zr), to avoid corrosion damage. The conversion layer 4 particularly preferably completely envelops the metal layer 5 on both sides. Furthermore, the covering layer 7 is closed off on both sides with a surface coating 6, with the surface coating 6 being, for example, cured, matt and black. Particular preference is given to the self-adhesive sealing composition of the adhesive element 1 adhering to a support element 3. The adhesive element 1 here is automatically separated when required, for example by means of a robot, from the support element 3 and subsequently automatically affixed to a component, for example to a body of a vehicle.

The support element 3, known as the liner, is in particular configured as prefabricated flat sheet on which a plurality of adhesive elements 1 are present. Here, the support element 3 is formed by paper, polyethylene or polyethylene terephthalate film having an antiadhesion layer. The sealing composition in a storage state is thus delimited on one side by the covering layer 7 and on the other side by the support element 3.

Since these adhesive elements 1 are preferably stuck on during the manufacturing process in order, for example, to avoid seeping-through of liquids, the adhesive elements 1 have to have sufficient adhesion and adhesive strength to allow the adhesive element 1 to close the opening effectively despite the stresses in the form of temperature, pressure and/or chemicals acting on the bodywork part in the manufacturing process and also in the final state.

It has surprisingly been found that an adhesive element 1 which withstands the stresses can be provided when a thermoactive or thermoactivated rubber composition 2 is used as sealing composition. Here, a person skilled in the art will, in the context of the present invention, understand a thermoactive or thermo-crosslinkable rubber composition 2 to be a composition which can be converted into the desired state by introduction of thermal energy and understand a thermoactivated rubber composition 2 to be a composition into which the thermal energy has already been introduced and is in the desired final state.

The statements and experiments set forth below concern, in particular, a rubber composition which comprises

| | |
|---|---|
| 7.0-10.0% | of a first type of rubber |
| 18.0-23.0% | of a second type of rubber |
| 8.0-10.0% | of hydrocarbon resin |
| 1.5-3.0% | of organic crosslinker |
| 0.5-2.0% | of catalyst |
| 0.2-0.6% | of dye |
| 2.5-4.0% | of thermal stabilizers and moisture removers and |
| 48.0-59.0% | of fillers. |

Here, the abovementioned constituents are mixed together and kneaded to give a highly viscous, thixotropic intermediate composition, i.e. a thermoactive rubber composition, in a production process for producing the sealing composition.

The intermediate composition is therefore advantageously suitable for a doctor blade process or calendering process by means of which the intermediate composition is processed further to give a self-adhesive film. The intermediate composition here preferably has a density in the range from 1.3 to 1.8 g/cm³.

The intermediate composition is preferably characterized by a dynamic viscosity measured at 120° C. and a shear rate of 20 1/s of from 100 to 140 Pas, a torque of 30-50 mNm, a peel strength at 100 mm/min of from 4 to 9 N/cm and heat resistance up to 240° C.

To produce the adhesive element 1, the self-adhesive film comprising the intermediate composition is preferably applied to the support element 3. On the side opposite the support element 3, this film is laminated with the covering layer 7 as described, for example, above. The adhesive elements can finally be shaped, preferably stamped, from this composite of support element 3, film comprising intermediate composition and covering layer 7.

It has advantageously been found that the intermediate composition having the above-described composition is transformed by thermal treatment into a sealing composition having desirable properties, in particular in respect of the adhesion values and impermeability of the adhesive bond, in respect of the mechanical properties such as hardness, ultimate tensile strength and/or in respect of insolubility in media such as oil, fuel, brake fluid or aqueous solutions.

FIG. 3 shows a graph of a degree of curing, in particular for the above-described composition, as a function of a residence time and a temperature. Here, the residence time is the time over which the intermediate composition, i.e. the thermoactive rubber composition, is subjected to the corresponding temperature. The closed box in the graph delimits the region in which the intermediate composition has, for the corresponding combination of temperature and residence time, led to a cured composition, i.e. to a thermoactivated rubber composition. In particular, it can be seen from the graph that the intermediate composition is thermally treated at a temperature in the range from 140° C. to 185° C. for a residence time corresponding to 45 and 10 minutes. Here, the thermal treatment of the intermediate composition brings about a course of a crosslinking process such that the self-adhesive intermediate composition is converted into a thermoset or permanently elastic, mechanically strong, rubber-like sealing composition which advantageously remains joined to the cathodically dip-coated substrate and to the metal layer 5 and/or surface coating 6 of the covering layer 7.

To achieve properties conforming to requirements, a particular combination of action of temperature and of residence time is required. In the present case, a temperature of 140° C. and a residence time of at least 30 minutes are the lowest parameters which ensure completion of the crosslinking process.

FIG. 4 shows a graph of a torque as a function of a temperature. This depiction allows conclusions to be drawn in respect of the flow behavior of the intermediate composition during the transition to the thermoactivated rubber composition. In particular, the increasing value of the torque with increasing temperature and time indicates the commencement and course of the crosslinking reaction, which brings about an increase in the viscosity and thus leads to an increase in the torque.

FIG. 5 shows a graph of a degree of crosslinking as a function of a temperature, in particular in each case for three different residence times. It can be seen that a degree of crosslinking which requires a force of more than 20 N in order to tear apart the crosslinked intermediate composition is attained at a residence time of 30 minutes and a temperature of at least 140° C., preferably a temperature of more than 160° C.

FIG. 6 shows a graph of a penetration force as a function of a temperature. In particular, the measured penetration force is shown as a function of the temperature here. It can be seen that the penetration force increases sharply at a temperature above 130° C. The penetration force is a measure of the force which is necessary to remove the adhesive element 1 from manufacturing-related openings, for example an opening in the vehicle body, and is thus a measure of the adhesion and the sealing capability of the adhesive element.

Since a penetration force of more than 500 N is preferably required, it is advantageous to treat the intermediate composition at a temperature above 160° C. so as to ensure the desired penetration force, in particular for the bodywork part, for the adhesive element 1.

After thermal activation, e.g. at a temperature of 160° C. for 20 minutes, the adhesive element 1 comprising the thermoactivated rubber composition 2 displays a penetration force in the range from 450 to 1200 N. Furthermore, the impermeability of the adhesive element 1 when closing an opening could be confirmed for a 500 mm water column. The corrosion resistance was KKK after 1000 h in accordance with DIN EN ISO 6270-2, SST after 3000 h in accordance with DIN 50021 or 20 cycles in a salt spray mist measurement in accordance with VDA 621-415. The combustability in accordance with DIN 75200 was 0-3 mm/min. In addition, the adhesive element 1 was physically and chemically resistant to fuel, oil, brake fluids, alcohol, organic solvents, dilute acids and alkalis, water and aqueous solutions.

### REFERENCE NUMERALS

1 Adhesive element
2 Rubber composition
3 Support element
4 Conversion layer
5 Metal layer
6 Surface coating
7 Covering layer

1. An adhesive element comprising
a covering layer and
a self-adhesive sealing composition,
wherein the self-adhesive sealing composition is a thermoactive or thermoactivated rubber composition.

2. The adhesive element as claimed in claim 1, wherein the covering layer comprises a metal layer.

3. The adhesive element as claimed in claim 1, wherein the rubber composition is configured so that it is converted into a thermoactivated state by means of heating above a temperature threshold for a residence time.

4. The adhesive element as claimed in claim 1, wherein a thermoactive rubber composition comprises a first type of rubber, a second type of rubber, a hydrocarbon resin, an organic crosslinker, a catalyst, a dye, a thermal stabilizer and/or a moisture remover.

5. The adhesive element as claimed in claim 1, wherein the thermoactive rubber composition comprises a filler.

6. The adhesive element as claimed in claim 1, wherein a ratio of a proportion of rubber to the proportion of the fillers assumes a value in the range from 0.3 to 0.8.

7. The adhesive element as claimed in claim 4, wherein
a proportion of the first type of rubber assumes a value in the range from 5 to 25%,
a proportion of the second type of rubber assumes a value in the range from 10 to 45%, and/or
a proportion of the filler assumes a value in the range from 40% to 70%.

8. The adhesive element as claimed in claim 1, wherein the adhesive element displays a penetration force of from 300 to 1200 N.

9. The adhesive element as claimed in claim 1, wherein the rubber composition is sulfur-free.

10. A process for producing an adhesive element, as claimed in claim 1, comprising the steps:
provision of an adhesive element comprising a covering layer and a self-adhesive sealing composition comprising a thermoactive or thermoactivated rubber composition and
introduction of thermal energy to convert the thermoactive rubber composition into a thermoactivated rubber composition.
